(19) United States
(12) Patent Application Publication
(10) Pub. No.: US 2016/0212455 A1
(43) Pub. Date: Jul. 21, 2016

(54) DYNAMIC PRODUCT PLACEMENT IN MEDIA CONTENT

(71) Applicant: INTEL CORPORATION, Santa Clara, CA (US)

(72) Inventor: Parbati K. MANNA, Portland, OR (US)

(21) Appl. No.: 14/129,658

(22) PCT Filed: Sep. 25, 2013
(86) PCT No.: PCT/US2013/061666

§ 371 Date: Dec. 27, 2013

(51) Int. Cl. H04N 21/234; H04N 21/81

(52) U.S. Cl. CPC H04N 21/23424; H04N 21/812

(57) ABSTRACT

Technologies for adaptively embedding advertising content into media content include a media content server for identifying a candidate content object within the media content to be replaced with an advertisement; replacing the identified candidate content object with an advertising placeholder; and associating a placeholder identifier with the advertising placeholder. Such technologies may also include detecting the placeholder identifier associated with the advertising placeholder within the media content; selecting an advertisement of a plurality of advertisements to embed within the advertising placeholder based on the placeholder identifier; embedding the selected advertisement within the media content by replacing the advertising placeholder with the selected advertisement; and transmitting the media content with the embedded advertisement to a media consumption device.

### BACKGROUND

Mass media advertising has become a ubiquitous tool for enabling companies to reach large numbers of consumers. A popular form of mass media advertising among companies is product placement. In this form of advertising, a company typically pays to have its brand or product incorporated into mass media content (e.g., a television show, a movie, a video game, etc.). Subsequently, when a person views the mass media content, the person is exposed to the company's product or brand.

Although product placement reaches a large number of consumers, it is a static form of advertising. That is, the placement of products or brands into media content is typically done when the content is created and, as a result, cannot be changed later. Therefore, the products or brands placed within the media content typically are not customized to a specific consumer of the media content and cannot be changed to target different audiences without re-creating the media content.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for using a media content server to adaptively embed an advertisement into media content;

FIG. 2 is a simplified block diagram of at least one embodiment of an environment of the media content server of the system of FIG. 1;

FIGS. 3A-3B is a simplified flow diagram of at least one embodiment of a method that may be executed by the media content server of FIGS. 1 and 2 for replacing a media content object with an advertising placeholder;

FIG. 4 is an illustrative embodiment of an advertisement placement map that may be used by the media content server of FIGS. 1 and 2 to adaptively embed an advertisement into media content;

FIG. 5 is an illustrative media content frame within which the media content server device of FIGS. 1 and 2 may replace a media content object with an advertising placeholder;

FIG. 6 is a simplified flow diagram of at least one embodiment of a method that may be executed by the media content server of FIGS. 1 and 2 for adaptively embedding an advertisement into media content; and

FIG. 7 is an illustrative media content frame within which the media content server device of FIGS. 1 and 2 may replace an advertising placeholder with an advertisement.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

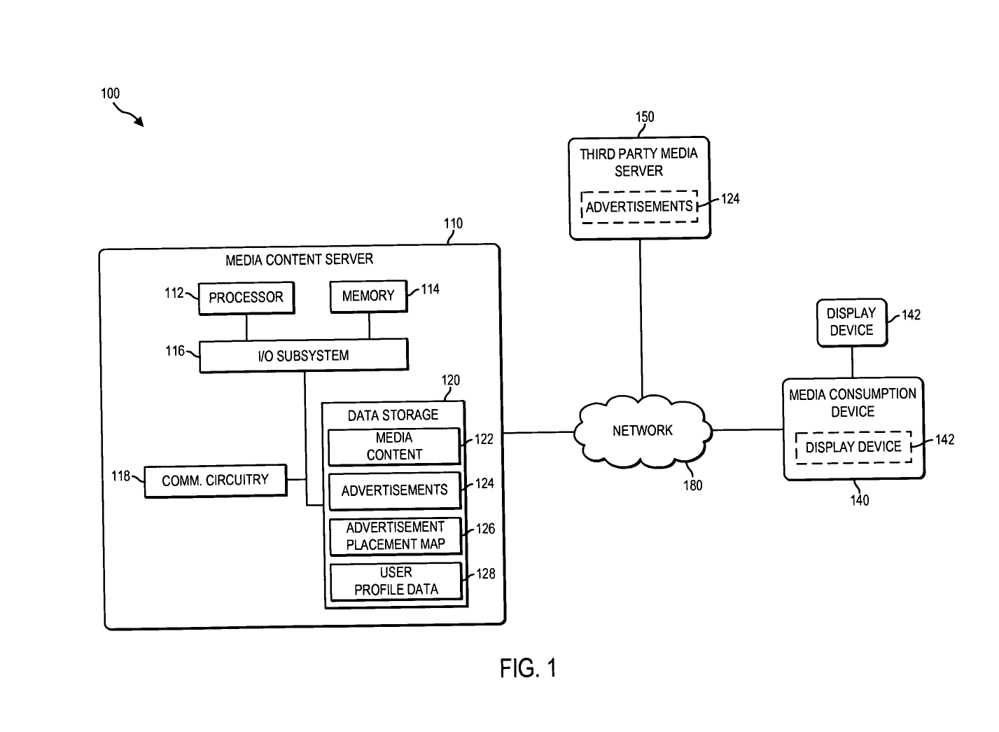

Referring now to FIG. 1, in an illustrative embodiment, a system 100 for using a media content server to adaptively embed an advertisement into media content includes a media content server 110 and a media consumption device 140. In use, the media content server 110 is configured to identify a content object (e.g., a product, an article, sign, poster, billboard, an audible sound, textual characters, etc.) within media content 122 (e.g., video content, multimedia content, audio content, interactive web content, a video game, etc.) that may later be replaced with an advertisement 124. For example, the media content server 110 may identify a can of soda presented in the media content 122 that may be subsequently replaced with an advertisement 124 of a particular brand of soda. Upon identifying a content object (i.e., a candidate content object) within the media content 122 that may be replaced, the media content server 110 replaces the candidate content object with an advertising placeholder. As discussed in more detail below, the advertising placeholder may be embodied as a visual, audible, and/or an executable placeholder based at least in part on, or otherwise as a function of, the content type (e.g., visual content, audible content, etc.) of the candidate content object identified. After replacing the candidate content object with an advertising placeholder having the same or a substantially similar content type, the media content server 110 associates a placeholder identifier with the advertising placeholder. As discussed in more detail below, the placeholder identifier may facilitate selecting one or more advertisements 124 that may later replace the advertising placeholder.

The media content server 110 is also configured to subsequently embed an advertisement 124 in the media content 122 (e.g., in response to a request for the media content server 110 from the media consumption device 140). To do so, the media content server 110 is configured to detect an advertising placeholder within the media content 122. In response, the media content server 110 selects a particular advertisement 124 to replace the advertising placeholder detected in the media content 122. In use, the particular advertisement 124 may be selected based at least in part on, or otherwise as a function of, an advertisement placement map 126 maintained by the media content server 110. In some embodiments, the media content server 110 may also use user profile data 128, or other data and/or methodology, to facilitate selecting a particular advertisement 124. Upon selecting the particular advertisement 124, the media content server 110 replaces (e.g., substitute, overlay, superimpose, etc.) the advertising placeholder with the selected advertisement 124. The media content server 110 may then transmit the media content 122 including the embedded advertisement 124 to the media consumption device 140 to be displayed to an end user. In some embodiments, the media content server 110 may receive advertisements, media content, user profile data, and/or the advertisement placement map from a third party media server 150.

The media content server 110 may be embodied as any type of computing device capable of performing the functions described herein including, but not limited to, a server, a desktop computer, a laptop computer, a consumer electronic device, a set-top box, a smart television, a smart display device, a mobile phone, a smart phone, a tablet computing device, a personal digital assistant, and/or other type of computing device. As shown in FIG. 1, the illustrative media content server 110 includes a processor 112, a memory 114, an input/output (I/O) subsystem 116, communication circuitry 118, and a data storage 120. Of course, the media content server 110 may include other or additional components, such as those commonly found in a server and/or computer (e.g., various input/output devices), in other embodiments. Additionally, in some embodiments, one or more of the illustrative components may be incorporated in, or otherwise from a portion of, another component. For example, the memory 114, or portions thereof, may be incorporated in the processor 112 in some embodiments.

The processor 112 may be embodied as any type of processor capable of performing the functions described herein. For example, the processor 112 may be embodied as a single or multi-core processor(s), digital signal processor, microcontroller, or other processor or processing/controlling circuit. Similarly, the memory 114 may be embodied as any type of volatile or non-volatile memory or data storage capable of performing the functions described herein. In operation, the memory 114 may store various data and software used during operation of the media content server 110 such as operating systems, applications, programs, libraries, and drivers. The memory 114 is communicatively coupled to the processor 112 via the I/O subsystem 116, which may be embodied as circuitry and/or components to facilitate input/output operations with the processor 112, the memory 114, and other components of the media content server 110. For example, the I/O subsystem 116 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 116 may form a portion of a system-on-a-chip (SoC) and be incorporated, along with the processor 112, the memory 114, and other components of the media content server 110, on a single integrated circuit chip.

The communication circuitry 118 of the media content server 110 may be embodied as any type of communication circuit, device, or collection thereof, capable of enabling communications between the media content server 110, the media consumption device 140, the third party media server 150, and/or other computing devices. The communication circuitry 118 may be configured to use any one or more communication technologies (e.g., wireless or wired communications) and associated protocols (e.g., Ethernet, Wi-Fi®, WiMAX, etc.) to effect such communication. In some embodiments, the media content server 110, the media consumption device 140, and the third party media server 150 communicate with each other over a network 180.

The network 180 may be embodied as any number of various wired and/or wireless communication networks. For example, the network 180 may be embodied as or otherwise include a local area network (LAN), a wide area network (WAN), a cellular network, or a publicly-accessible, global network such as the Internet. Additionally, the network 180 may include any number of additional devices to facilitate communication between the media content server 110, the media consumption device 140, the third party media server 150, and/or the other computing devices.

The data storage 120 may be embodied as any type of device or devices configured for short-term or long-term storage of data such as, for example, memory devices and circuits, memory cards, hard disk drives, solid-state drives, or other data storage devices. In the illustrative embodiment, the data storage 120 may include media content 122, one or more advertisements 124, an advertisement placement map 126, and user profile data 128. As discussed in more detail below, the media content 122 may be embodied as any type of media content (e.g., standard video content, 3D video content, multimedia content, interactive web content, a video game, a live television broadcast, audio content, an e-book, etc.). Each of the one or more advertisements 124 may be embodied as one or more visual advertisements (e.g., images, textual characters, slogans, video segments, etc.) and/or audible advertisements (e.g., sounds, music, spoken words, etc.) configured to be embedded within the media content 122 by the media content server 110. As discussed in more detail below, the user profile data 128 maintained in the data storage 120 may include information associated with a user of the media consumption device 140. For example, the user profile data 128 may include biographical information (e.g., characteristics corresponding to a particular user such as age, gender, residence, income, ethnicity, etc.), demographical information (e.g., biographical characteristics in common to a group of users, etc.), preferences, and/or online activity history (e.g., web searches, email content, social media posts, online purchases, etc.).

The media consumption device 140 may be embodied as any type of computing device capable of performing the functions described herein including, but not limited to, a desktop computer, a set-top box, a smart display device, a server, a mobile phone, a smart phone, a tablet computing device, a personal digital assistant, a consumer electronic device, a laptop computer, a smart television, and/or other type of computing device and/or media consumption device. As such, the media consumption device 140 may include devices and structures commonly found in computing devices such as processors, memory devices, communication circuitry, and data storages, which are not shown in FIG. 1 for clarity of the description. In some embodiments, the media consumption device 140 receives media content 122 from the media content server 110 having one or more advertisements 124 embedded therein. In such embodiments, the media consumption device 140 may display and/or present the received media content 122 to a user via a display device 142 and/or another type of playback device (e.g., a speaker, a portable music player, a projector, etc.).

The display device 142 may be embodied as any type of display device capable of performing the functions described herein. For example, the display device 142 may be embodied as any type of display device capable of displaying media content 122 to a user including, but not limited to, a television, a smart display device, a desktop computer, a monitor, a laptop computer, a mobile phone, a smart phone, a tablet computing device, a personal digital assistant, a consumer electronic device, a server, and/or any other display device. As discussed in more detail below, the display device 142 may be configured to present (e.g., display) media content 122 including targeted and/or personalized advertising content embedded therein. Additionally, although the display device 142 is separately connected to the media consumption device 140 in the illustrative embodiment of FIG. 1, it should be appreciated that display device 142 may be integrally included in the media consumption device 140 in other embodiments. Regardless, the display device 142 may include, or otherwise use, any suitable display technology including, for example, a liquid crystal display (LCD), a light emitting diode (LED) display, a cathode ray tube (CRT) display, a plasma display, and/or other display usable in a media consumption device to display the media content 122.

The third party media server 150 may be embodied as any type of server or similar computing device capable of performing the functions described herein. As such, the third party media server 150 may include devices and structures commonly found in servers such as processors, memory devices, communication circuitry, and data storages, which are not shown in FIG. 1 for clarity of the description. In some embodiments, the third party media server 150 is configured to provide media content (e.g., standard video content, 3D video content, multimedia content, interactive web content, a video game, a live television broadcast, audio content, an e-book, etc.), advertisements 124, and/or advertisement placement map data to the media content server 110.

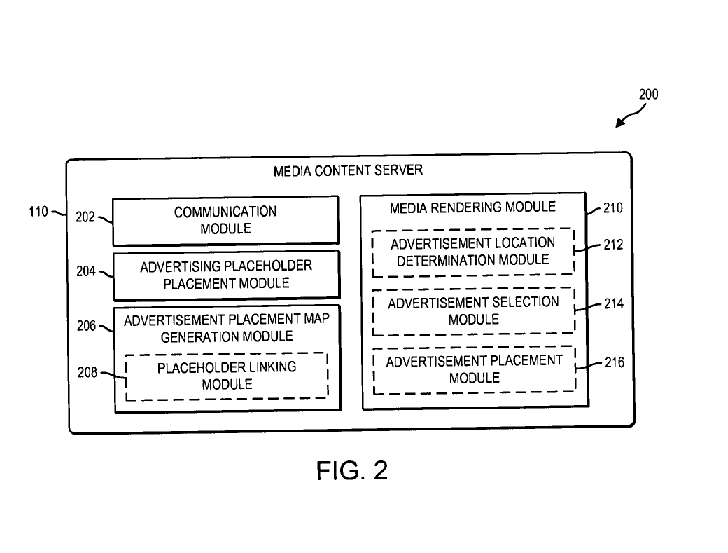

Referring now to FIG. 2, in use, the media content server 110 establishes an environment 200 during operation. The illustrative environment 200 includes a communication module 202, an advertising placeholder placement module 204, an advertisement placement map generation module 206, and a media rendering module 210. In some embodiments, the advertisement placement map generation module 206 illustratively includes a placeholder linking module 208. Additionally, as discussed in more detail below, the media rendering module 210 illustratively includes an advertisement location determination module 212, an advertisement selection module 214, and an advertisement placement module 216. Each of the modules 202, 204, 206, 208, 210, 212, 214, and 216 of the environment 200 may be embodied as hardware, software, firmware, or a combination thereof. It should be appreciated that the media consumption device 140 may include other components, sub-components, modules, and devices commonly found in a server, which are not illustrated in FIG. 2 for clarity of the description.

The communication module 202 of the media content server 110 facilitates communications between components or sub-components of the media content server 110 and the media consumption device 140 and/or the third party media server 150. For example, in some embodiments, the media content server 110 may send (e.g., transmit) media content 122 including embedded advertisements 124 to the media consumption device 140 for presentation (e.g., display, playback, etc.) to a user. Additionally or alternatively, the communication module 202 may receive the media content 122, one or more advertisements 124, advertisement map data, and/or user profile data from the third party media server 150 in other embodiments.

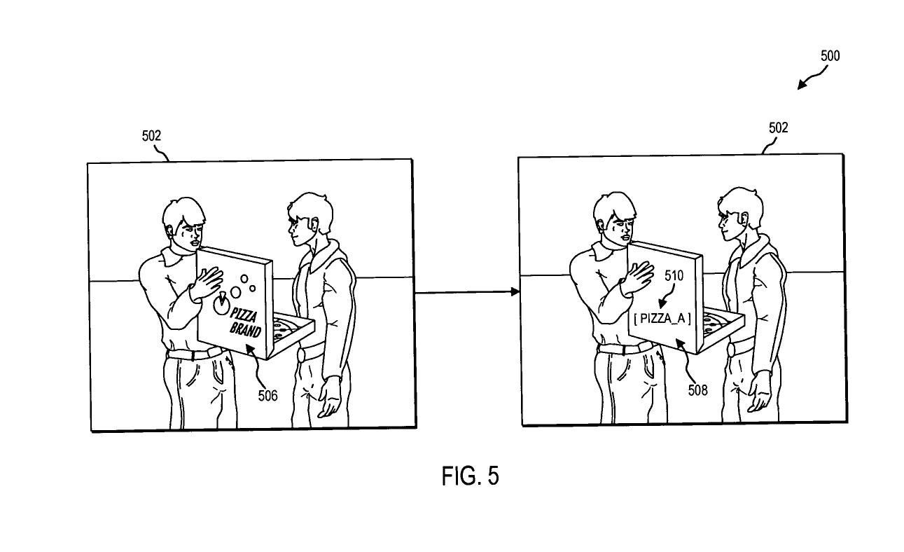

The advertising placeholder placement module 204 is configured to determine a location within the media content 122 at which an advertisement 124 may be later embedded. To do so, the advertising placeholder placement module 204 is configured automatically identify (e.g., without user intervention) an object or portion of content (e.g., the candidate content object) within the media content 122 that may be replaced with an advertising placeholder. As discussed, the media content 122 may be embodied as visual content, audible content, and/or a combination thereof (e.g., multimedia content). In embodiments wherein the media content 122 is embodied as visual content, the object or portion of content identified by the advertising placeholder placement module 204 may be embodied as any object, area, device, or structure displayed in the one or more images of the media content 122 on which advertising content may be displayed (e.g., a pizza box, a billboard, product packaging, t-shirts, containers, bumper stickers, etc.). For example, as illustratively shown in FIG. 5, the advertising placeholder placement module 204 may be configured to use a visual analysis procedure (e.g., image analysis, an object detection algorithm, a feature detection algorithm, video analysis, textual analysis, etc.) to determine the location of a pizza box lid 506 existing in one or more images 502 of the media content 500. Additionally or alternatively, in embodiments wherein the media content 122 includes audible content, the object or portion of content identified by the advertising placeholder placement module 204 may be embodied as any sound (e.g., music track, spoken dialog, sound segment, etc.) present in the media content 122 that may be replaced with an audible advertisement (e.g., sounds, music, spoken words, etc.). For example, the advertising placeholder placement module 204 may be configured to use audio analysis to identify an audible content object of the media content 122.

Referring back to FIG. 2, upon identifying the candidate content object within the media content 122, the advertising placeholder placement module 204 is configured to replace the identified candidate content object with an advertising placeholder. The advertising placeholder may be embodied as a visual, audible, and/or an executable placeholder (e.g., a hook, etc.) based at least in part on, or otherwise as a function of, the content type (e.g., visual content, audible content, etc.) of the identified candidate content object. For example, as illustratively shown in FIG. 5, the advertising placeholder placement module 204 may be configured to replace the pizza box lid 506 (e.g., a visible content object) with a visual (e.g., visible) advertising placeholder 508. In embodiments, wherein the media content 122 includes an audible content object, the advertising placeholder placement module 204 may replace the audible content object with an audible advertising placeholder. As discussed in more detail below, the advertising placeholder may later be replaced with an advertisement 124 selected based at least in part on the advertisement placement map 126 and/or the user profile data 128. Additionally, it should be appreciated that the advertising placeholder placement module 204 may identify and replace any number of objects or portions of content within the media content 122 with any number of advertising placeholders.

In some embodiments, the advertising placeholder placement module 204 is configured to determine whether the identified candidate content object within the media content 122 includes an existing advertisement. In such embodiments, the advertising placeholder placement module 204 is configured to replace the existing advertisement with an advertising placeholder as discussed above. The existing advertisement may be embodied as any type of advertisement (e.g., brand, product, logo, sign, poster, billboard, article, image, slogan, song, sound clip, text, campaign message, public service announcement, etc.) previously existing on and/or included within one or more candidate content objects within the media content 122. For example, in an illustrative embodiment, the existing advertisement may be embodied as a brand name visually printed on a soda can presented within the media content 122. In another illustrative embodiment, the existing advertisement may be embodied as a portion of the media content's 122 soundtrack (e.g., a segment of the soundtrack, a sound clip from the soundtrack, etc.) in which an actor speaks the brand name. It should also be understood that in some embodiments the presence of an existing advertisement on one or more candidate content objects within the media content 122 may or may not have been paid for by the owner and/or sponsor (e.g., a brand owner, a marketing service, a company, an individual, etc.) of the person, place, and/or thing (e.g., brand, product, logo, sign, poster, billboard, article, image, slogan, song, sound clip, text, campaign message, public service announcement, etc.) being advertised. That is, in some embodiments, a creator of the media content 122 may place an existing advertisement within the media content 122 without receiving prior payment and/or authorization to do so by the owner and/or sponsor of the existing advertisement. For example, in some embodiments, the creator of the media content 122 may place an existing advertisement into the media content 122 without the owner and/or sponsor's prior authorization and/or payment in order to provide the user (e.g., a viewer, content consumer, etc.) with additional context to and/or understanding of the media content's 122 storyline (e.g., plot, script, etc.).

As discussed, in some embodiments, the advertising placeholder placement module 204 is configured to determine whether the identified candidate content object within the media content 122 includes an existing advertisement. To do so, the advertising placeholder placement module 204 may be configured to first determine whether the existing advertisement (or the candidate content object itself) is permitted to be replaced with an advertising placeholder. To do so, the advertising placeholder placement module 204 may be configured to analyze the media content 122 to determine whether replacing the existing advertisement and/or the identified candidate content object with an advertising placeholder (and ultimately a different advertisement 124) would introduce inconsistencies within the media content 122 (e.g., changing the script, rendering portions of the media content 122 nonsensical, etc.). For example, in some embodiments, the media content 122 may include an existing advertisement (e.g., a consumer vehicle of a specific make and model) having particular characteristics that are essential to the user's (e.g., a viewer's, content consumer's, etc.) understanding of the storyline (e.g., plot, script, etc.) of the media content 122. In such embodiments, replacing the existing advertisement with another advertisement 124 (e.g., a different consumer vehicle of a different make and model) may render portions of the media content 122 nonsensical. As a result, the advertising placeholder placement module 204 may determine that replacing the existing advertisement with an advertising placeholder (and ultimately a different advertisement 124) is prohibited because doing so would introduce inconsistencies into the media content 122. In some embodiments, the advertising placeholder placement module 204 may be configured to utilize one or more artificial intelligence-based techniques (e.g., search algorithms, mathematical optimization, and/or evolutionary computations; logic programming and/or automated reasoning; probabilistic algorithms; statistical-based learning methods; Bayesian networks; trained and/or boosted classifiers; machine learning; artificial neural networks; and/or any other artificial intelligence-based technique) to analyze the media content 122 and determine whether replacing the existing advertisement and/or the identified candidate content object with an advertising placeholder (and ultimately a different advertisement 124) would introduce inconsistencies into the media content 122. Additionally or alternatively, in some embodiments, the advertising placeholder placement module 204 may also use input data received from a user of the media content server 110 to determine whether the existing advertisement and/or the candidate content object identified within the media content 122 is permitted to be replaced with an advertising placeholder. In such embodiments, the user input data may define one or more advertisements 124 and/or candidate content objects that are prohibited from being replaced with an advertising placeholder. In a similar way, the advertising placeholder placement module 204 may, additionally or alternatively, be configured to verify the consistency of the media content 122 after replacement of an existing advertisement and/or identified content object with an advertising placeholder. It should be appreciated, however, that the advertising placeholder placement module 204 may replace any candidate content object identified within the media content 122 with an advertising placeholder regardless of whether the identified object includes an existing advertisement.

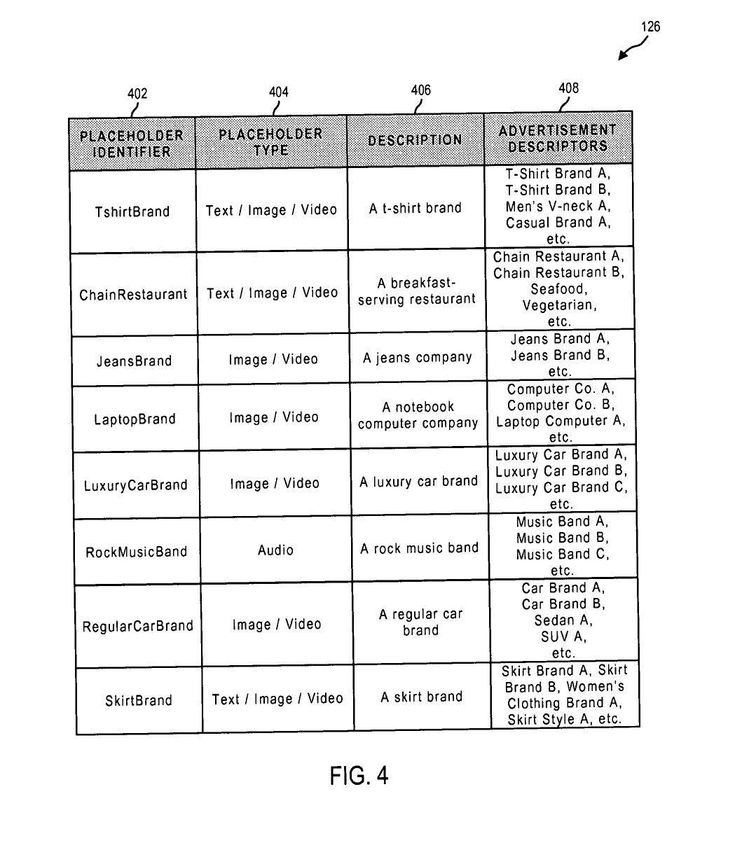

The advertising placeholder placement module 204 is further configured to associate a placeholder identifier (e.g., one of the illustrative placeholder identifiers 402 of FIG. 4) with the advertising placeholder. The placeholder identifier uniquely identifies the associated advertising placeholder and facilitates the later identification and/or detection of the advertising placeholder by the media content server 110. In some embodiments, the advertising placeholder placement module 204 associates the placeholder identifier with the advertising placeholder via metadata of the media content 122. In such embodiments, the media content server 110 may be configured to obtain the placeholder identifier using the metadata. It should be appreciated that in some embodiments the metadata of the media content 122 may also include any type of information (e.g., a starting frame time and an ending frame time, advertising placeholder location coordinates, etc.) to facilitate the later identification and/or detection of the advertising placeholder by the media content server 110. Additionally or alternatively, in some embodiments, the advertising placeholder placement module 204 is configured to embed an indicator within the advertising placeholder to facilitate the later identification and/or detection of the advertising placeholder by the media content server 110. In such embodiments, the indictor may include a visual indicator (e.g., a character string, a marking, a background color, a visual pattern, etc.), an audible indicator (e.g., a tone, a chord, a chirp, a series of sounds, etc.), and/or an executable indicator (e.g., a hook, embedded metadata, etc.) identifiable to the media content server 110. For example, as illustratively shown in FIG. 5, the advertising placeholder placement module 204 may embed a visual (e.g., visible) indicator 510 (e.g., “[PIZZA_A]”) within the visual advertising placeholder 508. Of course, it should be appreciated that the advertising placeholder placement module 204 may embed any number of indicators within the advertising placeholder.

In some embodiments, prior to associating the placeholder identifier with the advertising placeholder, the advertising placeholder placement module 204 may be configured to first determine whether there are any previous occurrences of the identified candidate content object (or an existing advertisement of the candidate content object) within the media content 122. To do so, the advertising placeholder placement module 204 may analyze the media content 122 via a visual analysis procedure, an audio analysis procedure, a textual analysis procedure, and/or a combination thereof to identify whether there is a previous occurrence of the candidate content object and/or the existing advertisement within the media content 122. In response to determining that there is a previous occurrence of the candidate content object and/or the existing advertisement within the media content 122, the advertising placeholder placement module 204 may retrieve the placeholder identifier associated with the advertising placeholder for the previous occurrence of the candidate content object and/or the existing advertisement. If, however, the advertising placeholder placement module 204 determines that there is not a previous occurrence of the candidate content object and/or the existing advertisement within the media content 122, the advertising placeholder placement module 204 may receive a new placeholder identifier from the advertisement placement map generation module 206 as discussed below.

The advertisement placement map generation module 206 may generate the advertisement placement map 126, which as discussed in more detail below, may be later used by the media rendering module 210 (or components thereof) to determine which advertisement 124 should replace the advertisement placeholder within the media content 122. As discussed, the media content 122 may include more than one advertising placeholder (e.g., a plurality of advertising placeholders) in some embodiments. In such embodiments, a portion or a subset of the plurality of advertising placeholders may be associated with one or more related content objects within the media content 122. For example, in embodiments wherein the media content 122 is embodied as video content, a particular content object may occur in any number of images (e.g., frames) of the video. Additionally or alternatively, different objects of different content types (e.g., visual, audible, textual, etc.) may be related. For example, the media content 122 may include both an image of a commercial product and an audio track of an actor speaking the name of that product. In such embodiments, the advertisement placement map generation module 206 may be configured to link or otherwise associate the placeholder identifiers of advertising placeholders corresponding to related content objects. In that way, related advertisements may be selected for related content objects regardless of the content type of the object.

In some embodiments, the advertisement placement map generation module 206 is also configured to generate placeholder identifiers. In use, the advertisement placement map generation module 206 may generate a new placeholder identifier in response to the advertising placeholder placement module 204 determining that there is not a previous occurrence of a candidate content object within the media content 122. Additionally, the advertisement placement map generation module 206 may be configured to generate one or more advertisement descriptors for the newly generated placeholder identifier. As discussed in more detail below, each advertisement descriptor (e.g., the illustrative advertisement descriptors 408 of FIG. 4) may identify characteristics (e.g., a brand, a product type, a specific product, etc.) of an advertisement that may later replace the advertising placeholder. In some embodiments, the advertisement placement map generation module 206 may also be configured to update the advertisement placement map 126 with the newly generated placeholder identifier and the one or more advertisement descriptors 408.

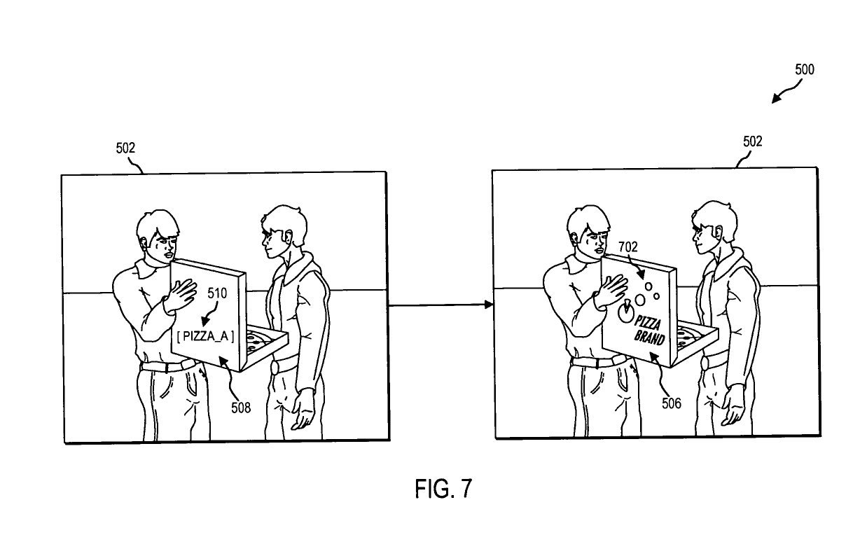

The media rendering module 210 is configured to embed or otherwise incorporate an advertisement 124 in the media content 122. To do so, the media rendering module 210 is configured to detect an advertising placeholder within the media content 122. In some embodiments, the media rendering module 210 includes the advertisement location determination module 212 to detect or otherwise identify the advertising placeholder within the media content 122. As discussed, advertising placeholders may be embodied as visual, audible, and/or executable placeholders that replace content objects of the media content 122. Additionally, each advertising placeholder may include a placeholder identifier embedded therein (e.g., an embedded indicator) or otherwise associated therewith (e.g., corresponding metadata, programming hooks, etc.) to facilitate identification. As such, the advertisement location determination module 212 may be configured to perform a video, audio, and/or content analysis procedure to identify the advertising placeholder and/or the placeholder identifier associated therewith. For example, in embodiments wherein the media content 122 is embodied as video content that includes a visible advertising placeholder (e.g., the visual advertising placeholder 508 of FIG. 7) within an image 502 of the media content 122, the advertisement location determination module 212 may be configured to utilize a visual analysis procedure (e.g., image analysis, an object detection algorithm, a feature detection algorithm, etc.) to detect and/or identify the visual (e.g., visible) indicator 510 embedded within the visual (e.g., visible) advertising placeholder 508. Additionally, as discussed above, metadata associated with the media content 122 may include information (e.g., a starting frame time and an ending frame time, advertising placeholder location coordinates, etc.) to facilitate the later identification and/or detection of an advertising placeholder, in some embodiments. In such embodiments, the media rendering module 210 is configured to detect and/or identify the advertising placeholder using the information included the metadata. It should be appreciated that detecting and/or identifying an advertising placeholder using metadata of the media content 122 may, in some embodiments, be faster and/or less resource intensive than performing a visual and/or audio analysis of the media content 122. It should also be appreciated that the advertisement location determination module 212 may detect and/or identify any number of advertising placeholders included within the media content 122 in other embodiments.

The media rendering module 210 is also configured to determine or otherwise select a particular advertisement 124 to be targeted to the user of the media consumption device 140. To do so, the media rendering module 210 may include an advertisement selection module 214, which in some embodiments may be configured to select a particular advertisement 124 from a plurality of advertisements 124. The advertisements 124 may be stored locally in the data storage 120 of the media content server 110 and/or received from the third party media server 150. In such embodiments, the advertisement selection module 214 may select the particular advertisement 124 based at least in part on, or otherwise as a function of, the advertisement placement map 126 (e.g., the advertisement placement map 126 illustratively shown in FIG. 4). In some embodiments, the advertisement selection module 214 may also utilize the user profile data 128 (e.g., biographical information, demographical information, one or more user interests, online activity information, user preferences, etc.) to facilitate selecting the particular advertisement 124.

The media rendering module 210 may also be configured to incorporate the selected advertising content into the media content 122. To facilitate such functionality, the media rendering module 210 may include the advertisement placement module 216. In such embodiments, the advertisement placement module 216 is configured to replace or modify (e.g., replace, incorporate, superimpose, overlay, etc.) the advertising placeholder with the selected advertisement 124. For example, as illustratively shown in FIG. 7, the advertisement placement module 216 may be configured to replace the visual advertising placeholder 508 with a visual (e.g., visible) advertisement 702. To ensure a seamless replacement of the advertising placeholder with the selected advertisement 124, the advertisement placement module 216 may be configured to perform an image, audio, and/or textual matching procedure on the selected advertisement 124. For example, in embodiments wherein the media content 122 is embodied as video content, the advertisement placement module 216 may match (or substantially replicate) the visual characteristics of the selected advertisement 124 (e.g., scale, orientation, alignment, contrast, background, color, font, style, formatting, etc.) with those of the advertising placeholder and/or the media content 122. In embodiments in which the media content 122 is embodied as audio content, the advertisement placement module 216 may match (or substantially replicate) the audible characteristics of the selected advertisement 124 (e.g., sound level, background noise, sampling frequency, tone, etc.) with those of the advertising placeholder and/or the media content 122.

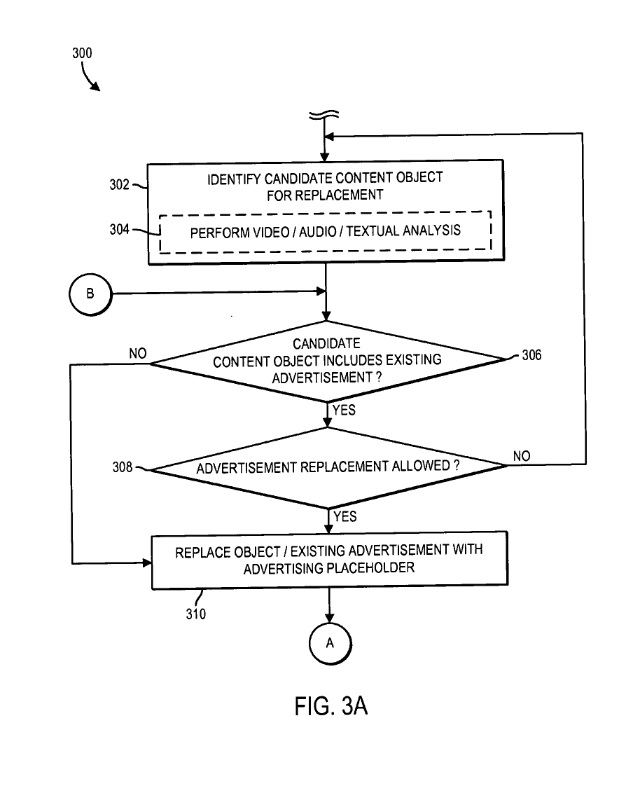

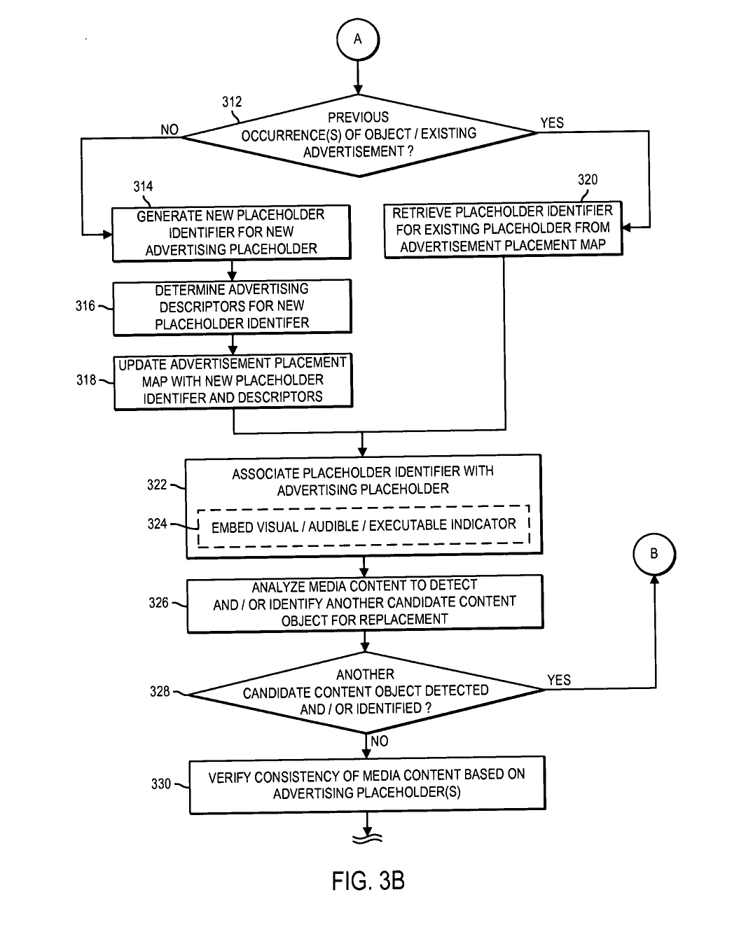

Referring now to FIGS. 3A-3B, the media content server 110 may execute a method 300 for replacing a media content object with an advertising placeholder. The method 300 begins with block 302 in which the media content server 110 identifies a candidate content object within media content 122 to be replaced with an advertising placeholder. As discussed above, the candidate content object may be embodied as a product, an article, sign, poster, billboard, an audible sound, textual characters, or other replaceable object contained in the media content. In some embodiments, in block 304, the media content server 110 may perform a visual analysis procedure (e.g., image analysis, an object detection algorithm, a feature detection algorithm, video analysis, textual analysis, etc.) and/or an audio analysis procedure on the media content 122 to identify a candidate content object. For example, as illustratively shown in FIG. 5, the media content server 110 may perform a visual analysis procedure to identify a pizza box lid 506 existing in one or more images 502 of the media content 500 as the candidate content object. It should be appreciated that in some embodiments the media content server 110 may also be configured to identify multiple (e.g., two or more) candidate content objects within the media content 122.

In some embodiments, in block 306, the media content server 110 determines whether the identified candidate content object within the media content 122 includes an existing advertisement. For example, in some embodiments, the media content server 110 may utilize a visual analysis procedure, an audio analysis procedure, a textual analysis procedure, and/or a combination thereof to compare the identified candidate content object to a plurality of reference advertisements stored in the data storage 120 of the media content server 110 or received from the third party media server 150. In such embodiments, the media content server 110 may determine that the identified candidate content object includes an existing advertisement in response to determining that the identified candidate content object matches or is substantially similar to one or more of the plurality of reference advertisements. If, in block 306, the media content server 110 determines that the identified candidate content object does not include an existing advertisement, the method 300 advances to block 310. If, however, the media content server 110 determines instead that the identified candidate content object includes an existing advertisement, the method 300 advances to block 308 in which the media content server 110 determines whether the existing advertisement is permitted to be replaced with an advertising placeholder. To do so, in some embodiments, the media content server 110 analyzes the media content 122 to determine whether replacing the existing advertisement with an advertising placeholder would introduce inconsistencies within the media content 122 (e.g., change the script, render the media content 122 nonsensical, etc.). In other embodiments, the media content server 110 may also utilize input data received from a user (e.g., a reviewer of the media content 122) indicative of whether replacement of the existing advertisement is permitted. It should be appreciated that in some embodiments, the media content server 110 may also determine whether the identified candidate content object is permitted to be replaced with an advertising placeholder.

In block 310, the media content server 110 replaces the candidate content object and/or the existing advertisement of the candidate content object with an advertising placeholder. To do so, the media content server 110 replaces the candidate content object and/or the existing advertisement of the candidate content object with an advertising placeholder having a substantially similar content type. In embodiments wherein the identified candidate content object comprises a visible content object (e.g., a product, an article, sign, poster, billboard, brand, etc.), the media content server 110 replaces the visible content object with a visible advertising placeholder. For example, as illustratively shown in FIG. 5, the media content server 110 may replace the pizza box lid 506 (e.g., a visible candidate content object) with a visual advertising placeholder 508. Additionally or alternatively, in embodiments wherein the identified candidate content object comprises an audible content object, the media content server 110 replaces the audible content object with an audible advertising placeholder. After replacing the candidate content object with the advertising placeholder, the method 300 advances to block 312.

In block 312, the media content server 110 determines whether there are any previous occurrences of the identified candidate content object and/or existing advertisement of the candidate content object within the media content 122. To do so, the media content server 110 analyzes the media content 122 via a visual analysis procedure, an audio analysis procedure, a textual analysis procedure, and/or a combination thereof to identify whether there is a previous occurrence of the candidate content object and/or the existing advertisement within the media content 122. If, in block 312, the media content server 110 determines that there is not a previous occurrence of the candidate content object and/or the existing advertisement within the media content 122, the method 300 advances to block 314.

In block 314, the media content server 110 generates a new placeholder identifier in response determining that there is not a previous occurrence of a candidate content object and/or existing advertisement within the media content 122. The media content server 110 may utilize any suitable methodology to generate the new placeholder identifier including, for example, randomly generating the new placeholder identifier, generating the new placeholder identifier based on pre-defined generation rules, etc. Subsequently, in block 316, the media content server 110 generates one or more advertisement descriptors for the newly generated placeholder identifier. As discussed, each advertisement descriptor identifies characteristics (e.g., a brand, a product type, a specific product, etc.) of an advertisement that may later be used to replace the advertising placeholder. In some embodiments, the media content server 110 may analyze the candidate content object and/or the existing advertisement to determine one or more characteristics (e.g., the brand, the product type, the specific product, etc.) associated therewith. Additionally, the media content server 110 may also analyze the media content 122 to facilitate determining the characteristics of the candidate content object and/or the existing advertisement. In such embodiments, the media content sever 110 may generate one or more advertisement descriptors that are indicative of the determined characteristics of the candidate content object and/or the existing advertisement. After generating the advertisement descriptors, the method 300 advances to block 318 in which the media content server 110 updates the advertisement placement map (see, e.g., the illustrative advertisement placement map 126 of FIG. 4) to include the newly generated placeholder identifier and advertisement descriptors. Subsequently, the method 300 advances to block 322.

Referring back to block 312, if the media content server 110 instead determines that there is a previous occurrence of the candidate content object and/or the existing advertisement within the media content 122, the method 300 advances to block 320. In block 320, the media content server 110 retrieves the existing placeholder identifier associated with the advertising placeholder for the previous occurrence of the candidate content object and/or the existing advertisement. The method 300 subsequently advances to block 322.

In block 322, the media content server 110 associates the existing placeholder identifier and/or the newly generated placeholder identifier with the advertising placeholder. In some embodiments, in block 324, the media content server 110 embeds an indicator within the advertising placeholder to facilitate the later identification and/or detection of the advertising placeholder. To do so, the media content server 110 embeds a visual indicator (e.g., a character string, a marking, a background color, a visual pattern, etc.), an audible indicator (e.g., a tone, a chord, a chirp, a series of sounds, etc.), and/or an executable indicator (e.g., a hook, embedded metadata, etc.) within the advertising placeholder based at least in part on, or otherwise as a function of, the content type (e.g., visual, audible, etc.) of the advertising placeholder. For example, as illustratively shown in FIG. 5, the media content server 110 may embed a visual indicator 510 (e.g., “[PIZZA_A]”) within the visual advertising placeholder 508.

In block 326, the media content server 110 analyzes the media content 122 to detect or otherwise identify another candidate content object within the media content 122 to be replaced with another advertising placeholder. To so do, in some embodiments, the media content server 110 performs a visual analysis procedure (e.g., image analysis, an object detection algorithm, a feature detection algorithm, video analysis, textual analysis, etc.) and/or an audio analysis procedure on the media content 122 to detect and/or identify another candidate content object (e.g., a different candidate content object) within the media content 122. Additionally or alternatively, in some embodiments, the media content server 110 detects and/or identifies both the candidate content object and the other candidate content object at the same or a substantially similar time (e.g., in blocks 302-304). The method 300 then advances to block 328 in which the media content server 110 determines whether another candidate content object to be replaced with another advertising placeholder is detected and/or identified within the media content 122. If, in block 328, the media content server 110 determines that another candidate content object to be replaced with another advertising placeholder is detected and/or identified within the media content 122, the method 300 loops back to block 306 to determine whether the other candidate content object identified within the media content 122 includes an existing advertisement. If, however, the media content server 110 instead determines in block 328 that another candidate content object is not detected and/or identified within the media content 122, the method 300 advances to block 330.

In some embodiments, in block 330, the media content server 110 verifies the consistency of the media content 122 after replacing an identified content object with an advertising placeholder. To so do, the media content server 110 analyzes the media content 122 to determine whether the replacement of any of the candidate content objects with an advertising placeholder introduced an inconsistency within the media content 122. In some embodiments, the advertising placeholder placement module 204 may also receive user input data indicative of one or more content object replacements that introduced an inconsistency into the media content 122.

An illustrative advertisement placement map 126 is shown in FIG. 4. The illustrative advertisement placement map 126 may include one or more placeholder identifiers 402. As discussed, each placeholder identifier 402 may be associated with a different advertising placeholder placed within the media content 122. Additionally, each placeholder identifier 402 of the advertisement placement map 126 may be associated with a placeholder type 404. The placeholder type 404 indicates the format (e.g., a placeholder content type) of the advertising placeholder associated with a particular placeholder identifier 402. For example, the placeholder type 404 of a particular placeholder identifier 402 may indicate that the associated advertising placeholder within the media content 122 is embodied as a textual advertising placeholder, a video advertising placeholder, and/or an image advertising placeholder. It should be appreciated that the advertisement placement map 126 may include placeholder identifiers 402 having any other placeholder types 404 (e.g., visual, audible, executable, etc.).

In some embodiments, the advertisement placement map 126 also includes a description 406 of each of the placeholder identifiers 402. For example, the description 406 may include a general explanation of the type of advertisement associated with a particular placeholder identifier 402. The advertisement placement map 126 may also include one or more advertisement descriptors 408 for each of the placeholder identifiers 402. Each advertisement descriptor 408 may identify characteristics (e.g., a brand, a product type, a specific product, etc.) of an advertisement that may later replace the advertising placeholder. As such, each advertisement descriptor 408 may be associated with a different advertisement 124 that is permitted to replace a particular advertising placeholder. Of course, it should be appreciated that the advertisement placement map 126 may include additional or other types of information (e.g., an advertiser/sponsor name, an advertising sequence number, a starting frame time and an ending frame time, a target date for display, a target time period for display, advertising placeholder location coordinates, etc.) to facilitate the selection of a particular advertisement 124 of the plurality of advertisements 124.

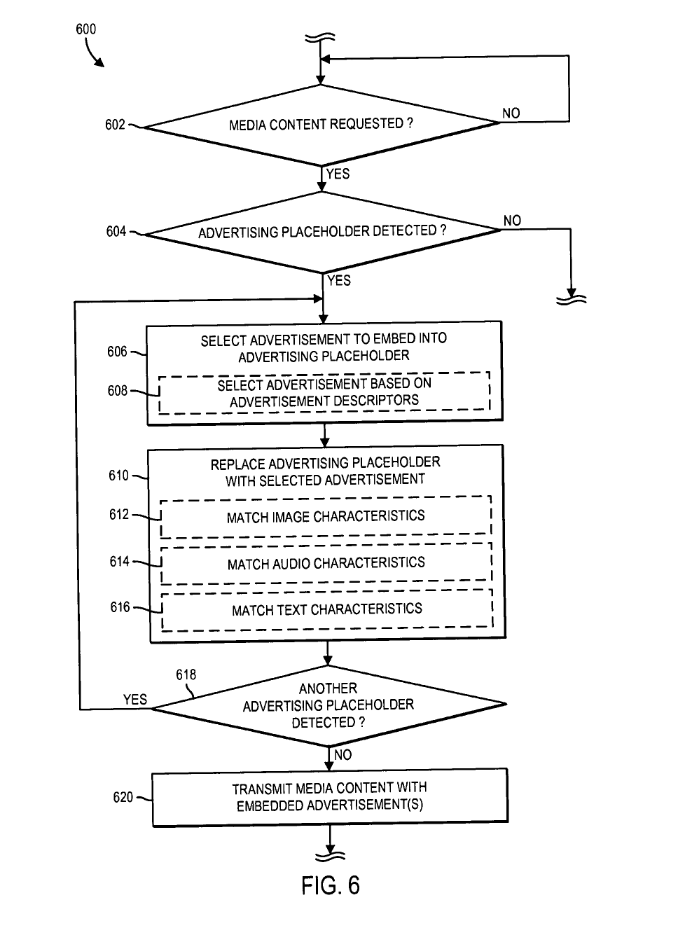

Referring now to FIG. 6, the media content server 110 may execute a method 600 for adaptively embedding an advertisement 124 into the media content 122. The method 600 begins with block 602 in which the media content server 110 determines whether a user of the media consumption device 140 has requested the media content 122. To do so, the media content server 110 may determine whether a message requesting the media content 122 has been received from the media consumption device 140. If, in block 602, the media content server 110 receives a message requesting the media content 122, the method 600 advances to block 604. If, however, a message requesting the media content 122 is not received, the method 600 returns to block 602 in which the media content server 110 continues to determine whether a message requesting the media content 122 has been received.

In block 604, the media content server 110 detects or otherwise identifies an advertising placeholder within the media content 122. To do so, the media content server 110 performs a video, audio, and/or content analysis procedure on the media content 122 to identify the advertising placeholder and/or a placeholder identifier associated therewith. In use, in some embodiments, the media content server 110 utilizes a visual analysis procedure (e.g., image analysis, an object detection algorithm, a feature detection algorithm, etc.) to detect and/or identify a visible identifier embedded within a visible advertising placeholder. For example, as illustratively shown in FIG. 7, the media content server 110 may perform a visual analysis procedure to detect and/or identify the visual (e.g. visible) indicator 510 embedded within the visual (e.g., visible) advertising placeholder 508. Additionally or alternatively, in some embodiments, the media content server 110 obtains metadata information (e.g., a starting frame time, an ending frame time, advertising placeholder location coordinates, etc.) associated with the media content 122 to facilitate detection and/or identification of the advertising placeholder. If, in block 604, the media content server 110 detects an advertising placeholder within the media content 122, the method 600 advances to block 606.

In block 606, the media content server 110 selects a particular advertisement 124 to be targeted to the user of the media consumption device 140. To do so, the media content server 110 selects the particular advertisement 124 based at least in part on the advertisement placement map 126. In some embodiments, in block 608, the media content server 110 selects the particular advertisement 124 based at least in part on one or more advertisement descriptors 408 included within the advertisement placement map 126 and that correspond to the placeholder identifier 402 associated with the advertising placeholder. For example, in some embodiments, the media content server 110 may compare the one or more advertisement descriptors 408 to the advertising placeholder to determine which advertisement descriptor 408 includes characteristic information that matches and/or is substantially similar to the characteristics of the candidate content object and/or the existing advertisement to be replaced. The media content server 110 may then select the particular advertisement associated with the determined advertisement descriptor 408. Additionally, in some embodiments, the media content server 110 utilizes user profile data 128 (e.g., biographical information, demographical information, one or more user interests, online activity information, user preferences, etc.) to facilitate selecting the particular advertisement 124.

Subsequently, in block 610, the media content server 110 incorporates the selected advertisement 124 into the media content 122. To do so, the media content server 110 replaces or modifies (e.g., replaces, incorporates, superimposes, overlays, etc.) the identified advertising placeholder with the selected advertisement 124. For example, as illustratively shown in FIG. 7, the advertisement placement module 216 may be configured to replace the visual advertising placeholder 508 with a visual (e.g., visible) advertisement 702. In some embodiments, in blocks 612-616, the media content server 110 performs an image, audio, and/or textual matching procedure on the selected advertisement 124 to ensure a seamless replacement of the advertising placeholder with the selected advertisement 124. For example, in block 612, the media content server 110 substantially matches the visual characteristics of the selected advertisement 124 (e.g., scale, orientation, alignment, contrast, background, color, etc.) with those of the advertising placeholder and/or the media content 122. In block 614, the media content server 110 substantially matches the audible characteristics of the selected advertisement 124 (e.g., sound level, background noise, sampling frequency, tone, etc.) with those of the advertising placeholder and/or the media content 122. Additionally, in block 616, the media content server 110 substantially matches the textual characteristics of the selected advertisement 124 (e.g., font, size, format, line spacing, color, numbering, etc.) with those of the advertising placeholder and/or the media content 122. After replacing the advertising placeholder with the selected advertisement 124, the method 600 advances to block 618.

In block 618, the media content server 110 determines whether the media content 122 includes another advertising placeholder. To do so, the media content server 110 performs a video, audio, and/or content analysis procedure on the media content 122 to detect whether the media content 122 includes another advertising placeholder and/or a placeholder identifier associated therewith. For example, in some embodiments, the media content server 110 utilizes a visual analysis procedure (e.g., image analysis, an object detection algorithm, a feature detection algorithm, etc.) to detect and/or identify another visible identifier embedded within a different visible advertising placeholder. Additionally or alternatively, in some embodiments, the media content server 110 obtains metadata information (e.g., a starting frame time, an ending frame time, advertising placeholder location coordinates, etc.) associated with the media content 122 to facilitate detection and/or identification of the advertising placeholder. It should be appreciated that in other embodiments the media content server 110 may determine that the media content 122 includes another advertising placeholder and/or another placeholder identifier during the same video, audio, and/or content analysis procedure performed in block 604. That is, the media content server 110 may detect and/or identify both the advertising placeholder and the other advertising placeholder (or the placeholder identifiers associated therewith) using the same video, audio, and/or content analysis procedure. If, in block 618, the media content server 110 determines that the media content 122 includes another advertising placeholder, the method 600 loops back to block 606 in which the media content server 110 selects another advertisement 124 to embed into the other advertising placeholder. If, however, the media content server 110 determines instead that the media content 122 does not include any other advertising placeholders, the method 600 advances to block 620.

In block 620, the media content server 110 transmits the media content 122 including the embedded advertisement(s) 124 to the media consumption device 140. In some embodiments, the media consumption device 140 displays or otherwise presents the media content 122 including the embedded advertisement(s) 124 to a user via the display device 142 and/or another output device (e.g., a speaker, a portable music player, projector, etc.).

In some embodiments, the media content server 110 may obtain the metadata information in response receiving a message from the media consumption device 140 requesting the media content 122 (e.g., block 602). In such embodiments, the media content server 110 may use the metadata information to expedite processing of the media content 122. For example, in some embodiments, the media content server 110 utilizes the metadata information to process only those portions of the media content 122 in which an advertising placeholder is present. In doing so, the media content server 110 may incorporate one or more advertisements 124 into one or more advertising placeholders without having to process all of the media content 122.

It should be appreciated that all or a portion of the functionality of the media content server 110 described above may instead be performed by the media consumption device 140 and/or the third party media server 150. For example, in some embodiments, the media consumption device 140 identify may identify a candidate content object within the media content 122 that may later be replaced with and advertisement 124. In such embodiments, the media consumption device 140 may be configured to replace the identified candidate content object with an advertising placeholder and associate a placeholder identifier with the advertising placeholder. The media consumption device 140 may also be configured to detect an advertising placeholder within the media content 122 based at least in part on, or otherwise as a function of, an advertisement placement map 126 maintained by the media consumption device 140 and/or received from the media content server 110. In some embodiments, the media consumption device 140 may also use user profile data 128, or other data and/or methodology, to facilitate selecting a particular advertisement 124. Upon selecting the particular advertisement 124, the media consumption device 140 may replace (e.g., substitute, overlay, superimpose, etc.) the advertising placeholder with the selected advertisement 124. The media content server 110 may then display and/or present the media content 122 including the embedded advertisement 124 to a user via the display device 142 and/or another type of playback device (e.g., a speaker, a portable music player, a projector, etc.).

### EXAMPLES

Illustrative examples of the technologies disclosed herein are provided below. An embodiment of the technologies may include any one or more, and any combination of, the examples described below.

Example 1 includes a media content server to adaptively embed advertising content into media content, the media content server including an advertising placeholder placement module to: identify a candidate content object within the media content to be replaced with an advertisement; replace the identified candidate content object with an advertising placeholder; and associate a placeholder identifier with the advertising placeholder.

Example 2 includes the subject matter of Example 1, and wherein the advertising placeholder placement module is further to determine whether the identified candidate content object includes an existing advertisement; and wherein to replace the identified candidate content object with the advertising placeholder includes to replace the existing advertisement of the candidate content object with an advertising placeholder in response to a determination that the candidate content object includes the existing advertisement.

Example 3 includes the subject matter of any of Examples 1 and 2, and wherein the advertising placeholder placement module is further to determine whether the candidate content object previously occurred within the media content.

Example 4 includes the subject matter of any of Examples 1-3, and further including an advertisement placement map generation module to: generate the placeholder identifier in response to a determination that the candidate content object has not previously occurred within the media content; determine an advertisement descriptor for the placeholder identifier, the advertisement descriptor identifies characteristics of the advertisement to replace the advertising placeholder; and update an advertisement placement map with the placeholder identifier and the advertisement descriptor.

Example 5 includes the subject matter of any of Examples 1-4, and wherein the advertising placeholder placement module is further to retrieve the placeholder identifier in response to a determination that the candidate content object has previously occurred within the media content.

Example 6 includes the subject matter of any of Examples 1-5, and wherein to identify the candidate content object within the media content to be replaced includes to perform at least one of a visual analysis procedure, an audio analysis procedure, or a textual analysis procedure on the media content to identify the candidate content object.

Example 7 includes the subject matter of any of Examples 1-6, and wherein the candidate content object includes at least one of a visual object or an audible object within the media content.

Example 8 includes the subject matter of any of Examples 1-7, and wherein to associate the placeholder identifier with the advertising placeholder includes to embed at least one of a visual indicator, an audible indicator, or an executable indicator within the advertising placeholder.

Example 9 includes the subject matter of any of Examples 1-8, and wherein the candidate content object includes a visual object and the advertising placeholder includes a visual advertising placeholder; wherein to identify the candidate content object within the media content to be replaced with the advertisement includes to identify the visual candidate content object within the media content to be replaced with a visual advertisement; and wherein to replace the identified candidate content object with the advertising placeholder includes to replace the identified visual candidate content object with the visual advertising placeholder.

Example 10 includes the subject matter of any of Examples 1-9, and wherein the candidate content object includes an audible object and the advertising placeholder includes an audible advertising placeholder; wherein to identify the candidate content object within the media content to be replaced with the advertisement includes to identify the audible candidate content object within the media content to be replaced with an audible; and wherein to replace the identified candidate content object with the advertising placeholder includes to replace the identified audible candidate content object with the audible advertising placeholder.

Example 11 includes the subject matter of any of Examples 1-10, and wherein the candidate content object includes a textual object and the advertising placeholder includes a textual advertising placeholder; wherein to identify the candidate content object within the media content to be replaced with the advertisement includes to identify the textual candidate content object within the media content to be replaced with a textual advertisement; and wherein to replace the identified candidate content object with the advertising placeholder includes to replace the identified textual candidate content object with the textual advertising placeholder.

Example 12 includes the subject matter of any of Examples 1-11, and wherein the advertising placeholder placement module is further to determine whether the candidate content object is allowed to be replaced based on an analysis of the media content.

Example 13 includes the subject matter of any of Examples 1-12, and wherein the advertising placeholder placement module is further to verify the consistency of the media content in response to replacement of the identified candidate content object with the advertising placeholder.

Example 14 includes the subject matter of any of Examples 1-13, and wherein the advertising placeholder placement module is further to: identify another candidate content object within the media content to be replaced with another advertisement; replace the another identified candidate content object with another advertising placeholder; and associate another placeholder identifier with the another advertising placeholder.

Example 15 includes the subject matter of any of Examples 1-14, and further including a media rendering module to: detect the placeholder identifier associated with the advertising placeholder within the media content; select an advertisement of a plurality of advertisements to embed within the advertising placeholder based on the placeholder identifier; and embed the selected advertisement within the media content via replacement of the advertising placeholder with the selected advertisement.

Example 16 includes the subject matter of any of Examples 1-15, and wherein the media rendering module is further to compare the placeholder identifier with an advertisement placement map, the advertisement placement map includes a plurality of advertisement descriptors that correspond to the placeholder identifier, each advertisement descriptor identifies characteristics of the advertisement to replace the advertising placeholder; and wherein to select the advertisement of the plurality of advertisements based on the placeholder identifier includes to select the advertisement based on the plurality of advertisement descriptors that correspond to the placeholder identifier.

Example 17 includes the subject matter of any of Examples 1-16, and wherein to detect the placeholder identifier associated with the advertising placeholder within the media content includes to perform at least one of a visual analysis procedure, an audio analysis procedure, or a textual analysis procedure on the media content to identify the placeholder identifier associated with the advertising placeholder.

Example 18 includes the subject matter of any of Examples 1-17, and wherein the selected advertisement includes a visual advertisement; and wherein the media rendering module is further to match image characteristics of the visual advertisement to image characteristics of at least one of the advertising placeholder or the media content.

Example 19 includes the subject matter of any of Examples 1-18, and wherein the selected advertisement includes an audible advertisement; and wherein the media rendering module is further to match audio characteristics of the audible advertisement to audio characteristics of at least one of the advertising placeholder or the media content.

Example 20 includes the subject matter of any of Examples 1-19, and further including a communication module to transmit the media content with the embedded advertisement to a media consumption device.

Example 21 includes a method for adaptively embedding advertising content into media content, the method including: identifying, by a media content server, a candidate content object within the media content to be replaced with an advertisement; replacing, by the media content server, the identified candidate content object with an advertising placeholder; and associating, by the media content server, a placeholder identifier with the advertising placeholder.

Example 22 includes the subject matter of Example 21, and further including determining, by the media content server, whether the identified candidate content object includes an existing advertisement; and wherein replacing the identified candidate content object with the advertising placeholder includes replacing the existing advertisement of the candidate content object with an advertising placeholder in response to determining that the candidate content object includes the existing advertisement.

Example 23 includes the subject matter of any of Examples 21 and 22, and further including determining, by the media content server, whether the candidate content object previously occurred within the media content.

Example 24 includes the subject matter of any of Examples 21-23, and further including: generating, by the media content server, the placeholder identifier in response to determining that the candidate content object has not previously occurred within the media content; determining, by the media content server, an advertisement descriptor for the placeholder identifier, the advertisement descriptor identifying characteristics of the advertisement to replace the advertising placeholder; and updating, by the media content server, an advertisement placement map with the placeholder identifier and the advertisement descriptor.

Example 25 includes the subject matter of any of Examples 21-24, and further including retrieving, by the media content server, the placeholder identifier in response to determining that the candidate content object has previously occurred within the media content.

Example 26 includes the subject matter of any of Examples 21-25, and wherein identifying the candidate content object within the media content to be replaced includes performing at least one of a visual analysis procedure, an audio analysis procedure, or a textual analysis procedure on the media content to identify the candidate content object.

Example 27 includes the subject matter of any of Examples 21-26, and wherein the candidate content object includes at least one of a visual object or an audible object within the media content.

Example 28 includes the subject matter of any of Examples 21-27, and wherein associating the placeholder identifier with the advertising placeholder includes embedding at least one of a visual indicator, an audible indicator, or an executable indicator within the advertising placeholder.

Example 29 includes the subject matter of any of Examples 21-28, and wherein the candidate content object includes a visual object and the advertising placeholder includes a visual advertising placeholder; wherein identifying the candidate content object within the media content to be replaced with the advertisement includes identifying the visual candidate content object within the media content to be replaced with a visual advertisement; and wherein replacing the identified candidate content object with the advertising placeholder includes replacing the identified visual candidate content object with the visual advertising placeholder.

Example 30 includes the subject matter of any of Examples 21-29, and wherein the candidate content object includes an audible object and the advertising placeholder includes an audible advertising placeholder; wherein identifying the candidate content object within the media content to be replaced with the advertisement includes identifying the audible candidate content object within the media content to be replaced with an audible; and wherein replacing the identified candidate content object with the advertising placeholder includes replacing the identified audible candidate content object with the audible advertising placeholder.

Example 31 includes the subject matter of any of Examples 21-30, and wherein the candidate content object includes a textual object and the advertising placeholder includes a textual advertising placeholder; wherein identifying the candidate content object within the media content to be replaced with the advertisement includes identifying the textual candidate content object within the media content to be replaced with a textual advertisement; and wherein replacing the identified candidate content object with the advertising placeholder includes replacing the identified textual candidate content object with the textual advertising placeholder.

Example 32 includes the subject matter of any of Examples 21-31, and further including determining, by the media content server, whether the candidate content object is allowed to be replaced based on an analysis of the media content.

Example 33 includes the subject matter of any of Examples 21-32, and further including verifying, by the media content server, the consistency of the media content in response to replacing the identified candidate content object with the advertising placeholder.

Example 34 includes the subject matter of any of Examples 21-33, and further including: identifying, by the media content server, another candidate content object within the media content to be replaced with another advertisement; replacing, by the media content server, the another identified candidate content object with another advertising placeholder; and associating, by the media content server, another placeholder identifier with the another advertising placeholder.

Example 35 includes the subject matter of any of Examples 21-34, and further including: detecting, by the media content server, the placeholder identifier associated with the advertising placeholder within the media content; selecting, by the media content server, an advertisement of a plurality of advertisements to embed within the advertising placeholder based on the placeholder identifier; and embedding, by the media content server, the selected advertisement within the media content by replacing the advertising placeholder with the selected advertisement.

Example 36 includes the subject matter of any of Examples 21-35, and further including comparing, by the media content server, the placeholder identifier with an advertisement placement map, the advertisement placement map includes a plurality of advertisement descriptors corresponding to the placeholder identifier, each advertisement descriptor identifying characteristics of the advertisement to replace the advertising placeholder; and wherein selecting the advertisement of the plurality of advertisements based on the placeholder identifier includes selecting the advertisement based on the plurality of advertisement descriptors corresponding to the placeholder identifier.

Example 37 includes the subject matter of any of Examples 21-36, and wherein detecting the placeholder identifier associated with the advertising placeholder within the media content includes performing at least one of a visual analysis procedure, an audio analysis procedure, or a textual analysis procedure on the media content to identify the placeholder identifier associated with the advertising placeholder.

Example 38 includes the subject matter of any of Examples 21-37, and wherein the selected advertisement includes a visual advertisement; and further including matching image characteristics of the visual advertisement to image characteristics of at least one of the advertising placeholder or the media content.

Example 39 includes the subject matter of any of Examples 21-38, and wherein the selected advertisement includes an audible advertisement; and further including matching audio characteristics of the audible advertisement to audio characteristics of at least one of the advertising placeholder or the media content.

Example 40 includes the subject matter of any of Examples 21-39, and further including transmitting, by the media content server, the media content with the embedded advertisement to a media consumption device.

Example 41 includes a media content server to adaptively embed advertising content into media content, the media content server including a processor; and a memory having stored therein a plurality of instructions that when executed by the processor cause the media content server to perform the method of any of Examples 21-40.

Example 42 includes one or more machine readable media including a plurality of instructions stored thereon that in response to being executed result in a media content server performing the method of any of Examples 21-40.

Example 43 includes a media content server to adaptively embed advertising content into media content, the media content server including means for performing the method of any of Examples 21-40.

1-25. (canceled)

26. A media content server to adaptively embed advertising content into media content, the media content server comprising:
an advertising placeholder placement module to:
identify a candidate content object within the media content to be replaced with an advertisement;
replace the identified candidate content object with an advertising placeholder; and
associate a placeholder identifier with the advertising placeholder.

27. The media content server of claim 26, wherein the advertising placeholder placement module is further to determine whether the identified candidate content object includes an existing advertisement; and
wherein to replace the identified candidate content object with the advertising placeholder comprises to replace the existing advertisement of the candidate content object with an advertising placeholder in response to a determination that the candidate content object includes the existing advertisement.

28. The media content server of claim 26, wherein the advertising placeholder placement module is further to:
determine whether the candidate content object previously occurred within the media content; and
retrieve the placeholder identifier in response to a determination that the candidate content object has previously occurred within the media content.

29. The media content server of claim 28, further comprising an advertisement placement map generation module to:
generate the placeholder identifier in response to a determination that the candidate content object has not previously occurred within the media content;
determine an advertisement descriptor for the placeholder identifier, the advertisement descriptor identifies characteristics of the advertisement to replace the advertising placeholder; and
update an advertisement placement map with the placeholder identifier and the advertisement descriptor.

30. The media content server of claim 26, wherein to identify the candidate content object within the media content to be replaced comprises to perform at least one of a visual analysis procedure, an audio analysis procedure, or a textual analysis procedure on the media content to identify the candidate content object; and
wherein the candidate content object comprises at least one of a visual object or an audible object within the media content.

31. The media content server of claim 26, wherein to associate the placeholder identifier with the advertising placeholder comprises to embed at least one of a visual indicator, an audible indicator, or an executable indicator within the advertising placeholder.

32. The media content server of claim 26, wherein the candidate content object comprises a visual object and the advertising placeholder comprises a visual advertising placeholder;
wherein to identify the candidate content object within the media content to be replaced with the advertisement comprises to identify the visual candidate content object within the media content to be replaced with a visual advertisement; and
wherein to replace the identified candidate content object with the advertising placeholder comprises to replace the identified visual candidate content object with the visual advertising placeholder.

33. The media content server of claim 26, wherein the candidate content object comprises an audible object and the advertising placeholder comprises an audible advertising placeholder;
wherein to identify the candidate content object within the media content to be replaced with the advertisement comprises to identify the audible candidate content object within the media content to be replaced with an audible; and
wherein to replace the identified candidate content object with the advertising placeholder comprises to replace the identified audible candidate content object with the audible advertising placeholder.

34. The media content server of claim 26, wherein the advertising placeholder placement module is further to determine whether the candidate content object is allowed to be replaced based on an analysis of the media content.

35. The media content server of claim 26, further comprising:
a media rendering module to: (i) detect the placeholder identifier associated with the advertising placeholder within the media content, (ii) select an advertisement of a plurality of advertisements to embed within the advertising placeholder based on the placeholder identifier, and (iii) embed the selected advertisement within the media content via replacement of the advertising placeholder with the selected advertisement; and
a communication module to transmit the media content with the embedded advertisement to a media consumption device.

36. The media content server of claim 35, wherein the media rendering module is further to compare the placeholder identifier with an advertisement placement map, the advertisement placement map comprises a plurality of advertisement descriptors that correspond to the placeholder identifier, each advertisement descriptor identifies characteristics of the advertisement to replace the advertising placeholder; and
wherein to select the advertisement of the plurality of advertisements based on the placeholder identifier comprises to select the advertisement based on the plurality of advertisement descriptors that correspond to the placeholder identifier.

37. The media content server of claim 35, wherein to detect the placeholder identifier associated with the advertising placeholder within the media content comprises to perform at least one of a visual analysis procedure, an audio analysis procedure, or a textual analysis procedure on the media content to identify the placeholder identifier associated with the advertising placeholder;
wherein the selected advertisement comprises a visual advertisement; and
wherein the media rendering module is further to match image characteristics of the visual advertisement to image characteristics of at least one of the advertising placeholder or the media content.

38. The media content server of claim 35, wherein to detect the placeholder identifier associated with the advertising placeholder within the media content comprises to perform at least one of a visual analysis procedure, an audio analysis procedure, or a textual analysis procedure on the media content to identify the placeholder identifier associated with the advertising placeholder;
wherein the selected advertisement comprises an audible advertisement; and
wherein the media rendering module is further to match audio characteristics of the audible advertisement to audio characteristics of at least one of the advertising placeholder or the media content.

39. One or more machine readable media comprising a plurality of instructions stored thereon that in response to being executed by a media content server, cause the media content server to:
identify a candidate content object within the media content to be replaced with an advertisement;
replace the identified candidate content object with an advertising placeholder; and
associate a placeholder identifier with the advertising placeholder.

40. The one or more machine readable media of claim 39, wherein the plurality of instructions further cause the media content server to:
determine whether the candidate content object previously occurred within the media content; and
retrieve the placeholder identifier in response to a determination that the candidate content object has previously occurred within the media content.

41. The one or more machine readable media of claim 40, wherein the plurality of instructions further cause the media content server to:
generate the placeholder identifier in response to a determination that the candidate content object has not previously occurred within the media content;
determine an advertisement descriptor for the placeholder identifier, the advertisement descriptor identifies characteristics of the advertisement to replace the advertising placeholder; and
update an advertisement placement map with the placeholder identifier and the advertisement descriptor.

42. The one or more machine readable media of claim 39, wherein to identify the candidate content object within the media content to be replaced comprises to perform at least one of a visual analysis procedure, an audio analysis procedure, or a textual analysis procedure on the media content to identify the candidate content object; and
wherein the candidate content object comprises at least one of a visual object or an audible object within the media content.

43. The one or more machine readable media of claim 39, wherein to associate the placeholder identifier with the advertising placeholder comprises to embed at least one of a visual indicator, an audible indicator, or an executable indicator within the advertising placeholder.

44. The one or more machine readable media of claim 39, wherein the candidate content object comprises a visual object and the advertising placeholder comprises a visual advertising placeholder;
wherein to identify the candidate content object within the media content to be replaced with the advertisement comprises to identify the visual candidate content object within the media content to be replaced with a visual advertisement; and
wherein to replace the identified candidate content object with the advertising placeholder comprises to replace the identified visual candidate content object with the visual advertising placeholder.

45. The one or more machine readable media of claim 39, wherein the candidate content object comprises an audible object and the advertising placeholder comprises an audible advertising placeholder;
wherein to identify the candidate content object within the media content to be replaced with the advertisement comprises to identify the audible candidate content object within the media content to be replaced with an audible; and
wherein to replace the identified candidate content object with the advertising placeholder comprises to replace the identified audible candidate content object with the audible advertising placeholder.

46. The one or more machine readable media of claim 39, wherein the plurality of instructions further cause the media content server to:
detect the placeholder identifier associated with the advertising placeholder within the media content;
select an advertisement of a plurality of advertisements to embed within the advertising placeholder based on the placeholder identifier;
embed the selected advertisement within the media content via replacement of the advertising placeholder with the selected advertisement; and
transmit the media content with the embedded advertisement to a media consumption device.

47. A method for adaptively embedding advertising content into media content, the method comprising:
identifying, by a media content server, a candidate content object within the media content to be replaced with an advertisement;
replacing, by the media content server, the identified candidate content object with an advertising placeholder; and
associating, by the media content server, a placeholder identifier with the advertising placeholder.

48. The method of claim 47, further comprising:
determining, by the media content server, whether the candidate content object previously occurred within the media content; and
retrieving, by the media content server, the placeholder identifier in response to determining that the candidate content object has previously occurred within the media content.

49. The method of claim 48, further comprising:
generating, by the media content server, the placeholder identifier in response to determining that the candidate content object has not previously occurred within the media content;
determining, by the media content server, an advertisement descriptor for the placeholder identifier, the advertisement descriptor identifying characteristics of the advertisement to replace the advertising placeholder; and
updating, by the media content server, an advertisement placement map with the placeholder identifier and the advertisement descriptor.

50. The method of claim 47, further comprising:
detecting, by the media content server, the placeholder identifier associated with the advertising placeholder within the media content;
selecting, by the media content server, an advertisement of a plurality of advertisements to embed within the advertising placeholder based on the placeholder identifier;
embedding, by the media content server, the selected advertisement within the media content by replacing the advertising placeholder with the selected advertisement; and
transmitting, by the media content server, the media content with the embedded advertisement to a media consumption device.
